(19) United States
(12) Patent Application Publication
(10) Pub. No.: US 2009/0122928 A1
(43) Pub. Date: May 14, 2009

(54) Apparatus and method for frequency estimation in the presence of narrowband gaussian noise

(75) Inventor: Moshe Twitto, Givat Shmuel (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 11/984,035

(22) Filed: Nov. 13, 2007

(51) Int. Cl. H04B 15/00

(52) U.S. Cl. 375/344

(57) ABSTRACT

A method of compensating for a frequency estimation bias due to sampled filtered noise of a channel filter, comprises: estimating autocorrelation functions for the impulse response of the channel filter over a range of frequencies; selecting one of the frequencies for use; estimating a noise spectral density of the sampled filtered noise; reading the autocorrelation function corresponding to the selected frequency; estimating the frequency bias as a function of the noise spectral density and the autocorrelation function for the selected frequency; and using the estimate to compensate for the frequency offset. The compensated signal is useful in such standard receiver functions as, automatic gain control (AGC), timing recovery, matched filtering/equalization and phase estimation and compensation.

### FIELD AND BACKGROUND OF THE INVENTION

The present invention is generally related to carrier frequency estimation circuit for digital demodulator operating on pass-band, digitally modulated signals, and a method of estimating the carrier frequency of the received data. More specifically, the present invention relates to carrier frequency estimation where traditional frequency estimators produce biased estimations due to a non-white additive Gaussian noise.

The purpose of digital communication is to deliver discreet data streams from one point to others. In order to achieve this purpose, a large variety of modulation methods have been developed over the years. Those methods can be conceptually divided into two categories: Baseband and Passband communications. Modulation methods which belong to the first category generally modulate the amplitude of a data-carrying pulse and transmit a sequence of such modulated pulses directly over some sort of wire (e.g., twisted pair). However, in order to be able to transmit data wirelessly, passband methods have been introduced. Moreover, even in wired systems, frequency multiplexing of different sources necessitates passband modulation techniques. In passband communication, the modulated data is frequency-translated into some frequency band, and then amplified and transmitted. In the process of frequency shifting, the bandwidth of the transmitted signal may be doubled, as compared to the bandwidth of the original, baseband signal. The extra bandwidth can be exploited by using the quadrature portion of the transmitted signal, hence also doubling the data rate. Examples of such modulation methods are quadrature amplitude modulation (QAM) and phase shift keying (PSK). In baseband representation, the discreet data can be seen as a stream of complex value symbols which multiply a data-carrying pulse. In mathematical form, it can be formulated as follows:

$$x ( t ) = {\sum }_{n} {a}_{n} g ( t - nT ) , \qquad ( 1 )$$

where {aₙ} is a sequence of complex data symbols, g(t) is the data-carrying pulse, and T is a symbol period. It is very common for g(t) to be a square root raised-cosine (SRRC) pulse, which is a perfectly band-limited pulse, which furthermore has the desired property that after matched-filtering the resulting pulse introduces no inter-symbol interference (ISI). After frequency translation, the passband signal can be put in the following form:

y(t)=real{x(t)·e^{j2πƒ}^{_{c}}^{t}}, (2)

where ƒ_{c} is the carrier frequency and j=\sqrt{−1}.

In order to properly demodulate and decode the data in the passband signal (2), the received signal may be downconverted to baseband, as in (1). Mathematically, this task is achieved by multiplying the received signal (2) by e^{-j2πƒ}^{_{c}}^{t}, and convolving the result with an impulse response of an appropriate low-pass filter. In practice, the process of down-converting is usually done in several stages. For example, in the digital video broadcasting standard for satellite DVB-S, ƒ_{c} is in the Ku band (generally between 10.7 GHz and 12.75 GHz). Firstly, a wide block of channels is downconverted to an intermediate frequency of usually 950 MHz to 1450 MHz, using the superheterodyne principle, and amplified. This is done by a component called a “Low-Noise Block” (LNB), which is generally located on or in the satellite dish. Then, the relatively low frequency signal may be carried over a coaxial cable to the set-top box. At the set-top box, a tuner selects the desired carrier, and completes the downcoverting process. Since the signal (I) is complex-valued, the tuner generally has two outputs, one for the real part of the signal and the other for the imaginary part. However, in real world conditions, the baseband signal from the tuner is not located precisely around zero frequency, but in some other near-DC frequency. This frequency error, or offset, is due to inaccuracies in the LNB as well as the tuner, whose oscillators are not matched exactly to one another or to the transmitter oscillator. In the above example, the frequency offset can be as large as ±5 MHz. Clearly, this frequency offset has to be compensated in the receiver. The outputs of the tuner are fed into an analog to digital converter (ADC), which sample the signal. The ADC sampling frequency may or may be not locked to the received signal's symbol rate. If the sampling frequency is locked to the received signal's symbol frequency, the sampling frequency may be as low as the symbols rate. If, on the other hand, it is not locked to the symbols rate, the sampling frequency may need to satisfy Nyquist's sampling theorem, i.e., it should be at least twice the desired signal's bandwidth. Usually, the sampling frequency is taken to be at least twice the symbol's rate. Within such receivers, the timing recovery is done digitally, by means of a digital interpolator. The present teaching itself is usable when the sampling frequency is at least twice the symbols rate.

The usual tasks of a receiver include automatic gain control (AGC), timing recovery, matched filtering/equalization and phase estimation and compensation. Some of the above tasks, however, can not be performed properly if a substantial frequency offset is present. For example, the performance of the well-known Gardner algorithm for timing recovery is degraded rapidly as the frequency offset exceeds 20% of the symbols' rate. Likewise, the signal to noise ratio (SNR) at the output of the matched filter also decrease considerably when the frequency offset is above 10% of the symbols' rate. Hence, a means to estimate and compensate the frequency offset at an early stage, preferably directly after the ADC, is crucial to the performance of a digital demodulator. Conventional receivers rely on the fact that if there is neither modulation nor noise, the phase of the digitized signal is incremented by 2πΔƒTₛ, where Δf is the frequency offset and Tₛ is the sampling period. The effect of white noise can be averaged out, and the effect of modulation is reduced when the ratio T/Tₛ becomes higher.

In order to extract the frequency offset from the received samples, it is common to use the circuit depicted schematically in FIG. 1. A complex multiplier 110 multiplies the input sample with the output from delay unit 120. The output of delay unit 120 is a delayed version of the complex conjugate of the input. The complex conjugate operation is done at unit 160. The result is accumulated by adder 130 and register 140. After accumulating a predetermined quantity of samples, the content of register 140 is passed through phase-extraction unit 150 which computes the phase of the complex number at its input, i.e., if the input of 150 is I+jQ then its output is arctan

$$( \frac{Q}{I} ) .$$

Controller 180 controls the content of register 140 and enables the output of phase-extractor 150. To complete the frequency estimation, multiplier 170 scales the output of 150 by

$$\frac{1}{2 π {T}_{s}} ,$$

and an estimation of the frequency offset is obtained. Compensation of that frequency offset can be done in either a feedforward or feedback manner.

In FIG. 2 a general circuit 200 to compensate the frequency offset in a feedback manner is described. In circuit 200, the input signal is entered to rotator 210, which rotates or offsets the input signal by the phase outputted from a numerically controlled oscillator (NCO) 220. The rotation is generally implemented as a complex multiplier which multiplies the input complex sample by a complex number which is composed of the cosine and sine of the NCO's output as its real and imaginary parts, respectively. The output of rotator 210 is entered into the frequency estimation circuit 230, which is depicted in detail in FIG. 1 referred to above. The output of 230 (that is, the frequency estimation) drives the NCO which completes the loop.

In FIG. 3, a feedforward scheme is described generally. Here, the input to frequency estimation unit 310 is directly from the ADC 320. The frequency estimation drives NCO 330 which in turn drives a rotator 340.

However, the methods described above suffer from inherent estimation bias in many practical situations, as we explain in greater detail below. Generally, the output of the tuner is passed through a filter which removes adjacent channels and restricts the additive Gaussian noise (AWGN) power at the tuner's output, hereinafter referred to as the channel filter. An ADC samples the output of the channel filter. This channel filter may be either a lowpass filter or a bandpass filter, depending on the overall receiver design. Generally a lowpass filter is used for satellite systems and a bandpass filter for other systems. For example, DVB-S receivers usually use tuners which downconvert the signal into near-baseband frequency, so the channel filter is a lowpass filter. In other receivers, such as a cable demodulator, for example, the tuner outputs the signal at some IF frequency, and the channel filter is a bandpass one. The present teaching is relevant to either one of the above setups.

Clearly, the noise at the channel filter's output is correlated with an autocorrelation function which is proportional to the deterministic autocorrelation function of the filter's impulse response. We denote the deterministic autocorrelation function of the filter's impulse response by Rₕ(τ), and its Fourier transform by Sₕ(ƒ), which is actually proportional to the power spectrum density (psd) of the noise. Denoting the filter's impulse response by h(t), Rₕ(τ) is thus related to h(t) by the following relationship:

$${R}_{h} ( τ ) = {\int }_{- ∞}^{∞} h ( t ) \cdot {h}^{*} ( t + τ ) d t , \qquad ( 3 )$$

where * denotes a complex conjugate.

The noise at the sampler output has a spectrum according to Eq. (4) below

$${S}_{n} ( f ) = \frac{{N}_{0}}{{T}_{s}} {\sum }_{n} {S}_{h} ( f - n / {T}_{s} ) , \qquad ( 4 )$$

where N₀ is the one-sided power spectral density of the AWGN.

The sampler output spectrum depends on the sampling frequency, as well as the fitter's impulse response, and in general is not white. Indeed, one can design a sampler plus filter system which produces white noise, but such a design is inflexible and does not reflect good-practice. The non-white noise introduces a bias into the signal which makes it difficult to estimate and compensate for the frequency offset. This in turn makes it difficult to perform the standard receiver functions such as to recover timing information.

### SUMMARY OF THE INVENTION

As explained, the prior art deals with the offset due to the inaccuracies in the oscillators etc, and there is a problem in that the non-white noise causes the prior art estimator to be biased due to the estimation technique used. The present embodiments provide estimates for the bias, and uses the estimate to compensate for the bias. The signal following compensation for the bias can be used to allow for non-biased compensation of the frequency offset.

The compensation of the frequency offset then allows for the standard receiver functions.

According to a first aspect of the present invention there is provided a digital receiver apparatus for providing frequency offset compensation in the presence of filtered noise, comprising:

a tuner having an analog channel filter and a sampler, the analog channel filter for excluding unwanted channels and noise, the tuner providing a filtered sampled output with non-white noise, the non-white noise giving rise to a frequency bias within the output;

a bias estimator associated with the sampled output of the channel filter, configured for estimating the frequency bias due to the non-white noise; and

an offset compensation mechanism, connected to the bias estimator, configured to use the bias estimate to provide compensation therefor, thereby to provide a bias compensated signal, therefrom to carry out frequency offset compensation.

In an embodiment, the bias estimator is configured to calculate the bias from a function of the impulse response of the channel filter and the deterministic autocorrelation function of the channel filter impulse response.

In an embodiment, the bias estimator is configured such that the calculation of the impulse response is obtained from a power spectral density of the filtered noise.

In an embodiment, the bias estimator is configured to feed the power spectral density to be subtracted from a real part of a first complex signal to form a subtracted real part, the first complex signal being a multiplication of the sampled signal with a delayed complex conjugate of itself, the subtracted real part together with an imaginary part of the first complex signal, thereby comprising unbiased information on the frequency offset of the filtered input signal.

In an embodiment, the bias estimator is connected downstream of a power estimator, and the power estimator is configured to obtain the noise power spectral density by carrying out a sweep of frequencies to determine a minimal power frequency at which power is minimum, the minimal power frequency being taken as a frequency at which the non-white noise is dominant, the power spectral density being extracted from the minimal power frequency, as the noise power spectral density.

the apparatus may comprise an autocorrelation function estimator to estimate the autocorrelation function of the channel filter, the autocorrelation function estimator comprising:

a white Gaussian noise generator for passing white Gaussian noise through the channel filter;

an analog-to-digital converter ADC to convert the channel filter's output to digital form; and

a multiplier for multiplying the output of the channel filter with a delayed complex conjugate of itself, the mean thereof providing the autocorrelation function of the input digital signal.

In an embodiment, the power estimator comprises:

a frequency shifter, configured to shift the spectrum of the input signal, such that intended frequency content is placed around zero frequency;

a digital low-pass filter located downstream of the frequency shifter to filter high frequency content from the shifted signal;

a power estimator located downstream of the low-pass filter to obtain an estimate of the power of the filtered signal;

a controller to control the frequency shifter to carry out the sweep of the frequencies of the signal, such as to allow the estimate to be obtained for each frequency; and

a memory device to record respective power estimations of the different frequency regions of the signal, such that the minimum power frequency is determinable.

An embodiment comprise a second frequency shifter to shift a digital signal received from a tuner to a desired frequency;

a first digital low pass filter initially configured with filter coefficients to enable power spectrum estimation;

and

a numerically-controlled oscillator (NCO) controllable by an offset compensated phase extracted and fed back from the offset estimator after the power spectral density estimation to provide a signal to the first low pass filter, the lowpass filter being configurable with further coefficients, thereby to allow the low pass filter to provide a compensated output.

In an embodiment, the first lowpass filter and a lowpass filter of the power estimation unit comprise configurations of the same hardware.

According to a second aspect of the present invention there is provided a method of compensating for bias due to sampled filtered noise of a channel filter, thereby to allow for unbiased compensation of a frequency offset, the method comprising:

estimating autocorrelation functions for the impulse response of the channel filter over a range of frequencies;

selecting one of the frequencies for use;

estimating a noise spectral density of the sampled filtered noise at the selected frequency;

reading the autocorrelation function corresponding to the selected frequency;

estimating the frequency bias as a function of the noise spectral density and the autocorrelation function for the selected frequency; and

using the bias estimate to compensate for the bias, thereby to form an unbiased signal for frequency offset compensation.

In an embodiment, the estimating the noise spectral density comprises:

sweeping a plurality of frequencies to obtain a minimal power frequency; and

obtaining the power spectral density of the minimal power frequency.

In an embodiment, the estimating the autocorrelation functions comprises multiplying the received signal by a delayed complex conjugate of itself to produce a first complex signal having a real part and a complex part.

In an embodiment, the estimating the frequency bias comprises subtracting the noise spectral density from the real part to form a subtracted real part, a signal comprising unbiased information of the frequency offset thereby being set up in a second complex signal formed from the complex part and the subtracted real part.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting. Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a block diagram showing a prior art frequency estimator.

FIG. 2 is a block diagram showing a prior art feedback frequency compensation system.

FIG. 3 is a block diagram showing a prior art feedforward frequency compensation system.

FIG. 4 is simplified block diagram illustrating a frequency estimator according to a first embodiment of the present invention.

FIG. 5 is a simplified block diagram illustrating a power estimation circuit according to the embodiment of FIG. 4.

FIG. 6 is a simplified schematic diagram of a setup which performs an autocorrelation function estimation for use in the present embodiments.

FIG. 7 is a simplified flow chart illustrating a method for produce unbiased frequency estimation from a signal embedded in filtered, un-white Gaussian noise according to an embodiment of the present invention.

FIG. 8 is a simplified block diagram showing a frequency estimation and compensation apparatus according to a second embodiment of the present invention.

FIG. 9 is a simplified flow chart illustrating a method of obtaining the noise power spectral density, according to an embodiment of the present invention.

FIG. 10 shows an example of a typical power spectrum at the output of a tuner, and a typical frequency response of an analog filter.

### DETAILED DESCRIPTION OF THE PREFERRED EMBODIMENT

The present embodiments teach a method and apparatus for removing the inherent bias due the non-white noise caused by sampling of the filter output. The signal with the bias removed or compensated for can then be used to remove the frequency offset, to produce a result which can then be used in standard receiver functions, for example to enable unbiased frequency estimation of residual carrier frequency.

In the following, we derive the frequency estimation bias, and introduce means to compensate for it. We denote the complex baseband noise by υ. The above conventional algorithm computes the expected value of r(nTₛ)·r*((n−1)Tₛ), where r(nTₛ) denotes the sampled noisy signal. The received signal can be expressed as

$$r ( {nT}_{s} ) = {\sum }_{k} {a}_{k} g ( {nT}_{s} - kT ) \cdot {e}^{{j ( 2 π Δ fnT + ϕ )}_{s}} + {υ}_{n} . \\ Hence , \\ E [ r ( {nT}_{s} ) \cdot {r}^{*} ( ( n - 1 ) {T}_{s} ) ] = {σ}_{a}^{2} {\sum }_{k} g ( {kT}_{s} - nT ) g ( ( k - 1 ) {T}_{s} - kT ) \cdot {e}^{j2 π Δ {fT}_{s}} + {\tilde{R}}_{n} ( {T}_{s} )$$

$$where$$

$${\tilde{R}}_{n} ( τ ) = {R}_{{υ}_{R}} ( τ ) + {R}_{{υ}_{I}} ( τ )$$

and R_{υ}_{_{R}}(τ), R_{υ}_{ₗ}(τ) are the autocorrelation functions of the real and imaginary part of the noise process U, respectively. If the filter's frequency response is symmetric with respect to its central frequency, as happens frequently in practice, then the real and imaginary parts of the noise are both statistically independent, and identically distributed. Thus, the autocorrelation of υ_{R} (or υₗ) is

$${R}_{{υ}_{R}} ( τ ) = \frac{{N}_{0}}{2} {R}_{h} ( τ ) .$$

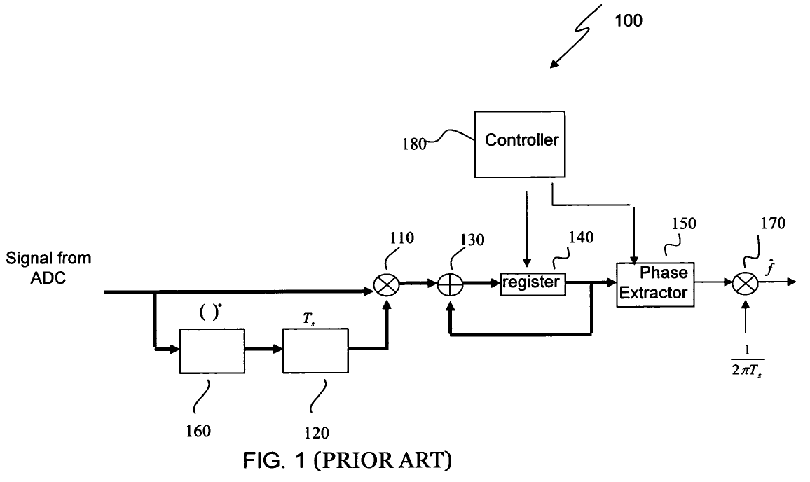

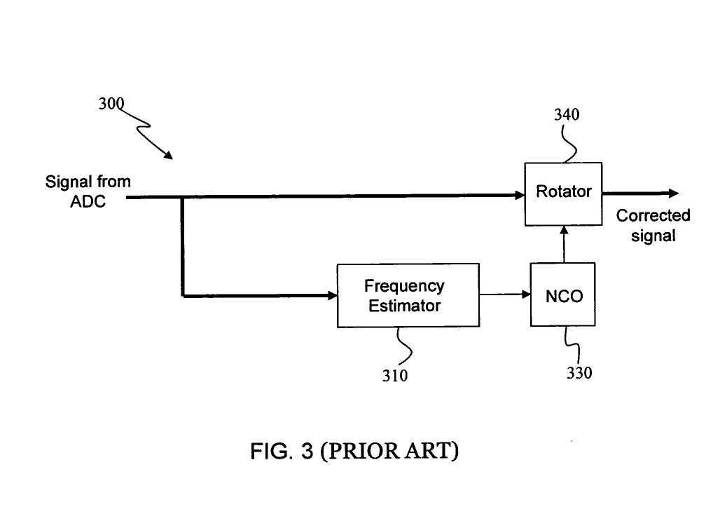

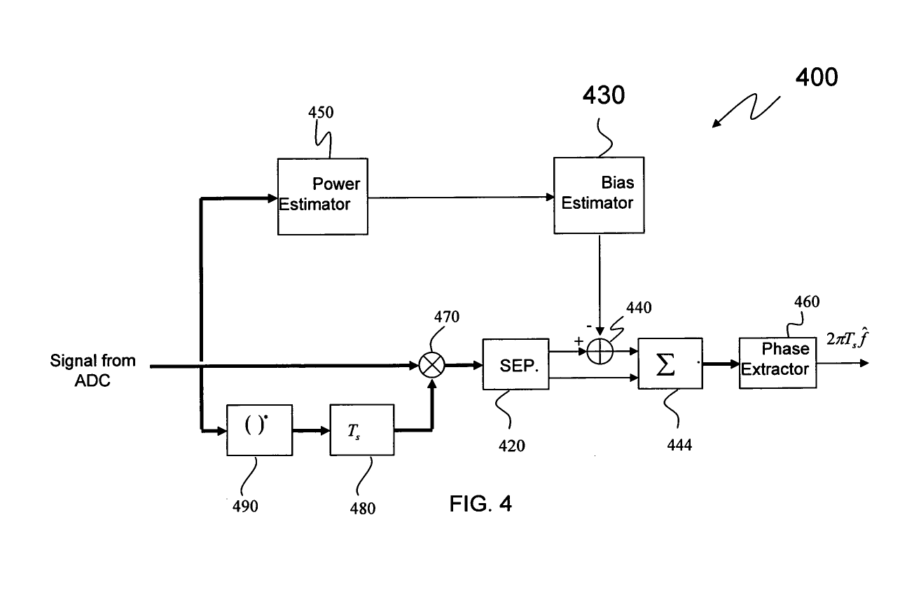

From the above it is clear that conventional estimators fail in the presence of correlated noise. A frequency estimator according to an embodiment of the present invention enables unbiased estimation of residual carrier frequency in the presence of filtered noise, in particular where the parts of the noise signal are correlated. Thus the frequency estimator of the present embodiments provides means to compensate frequency offset in real world systems, where the signal at the output of the tuners is filtered and thus biased. For purposes of better understanding some embodiments of the present invention, as illustrated in FIGS. 4-10 of the drawings, reference was made in the background to the construction and operation of a conventional frequency estimation system as illustrated in FIGS. 1-3.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

A frequency estimator according to a first embodiment of the present invention is shown in FIG. 4, and indicated generally at 400. Input samples are received of the filtered received signals. The input samples include non-white noise as explained above. The input signal is received by an upper and a lower branch, of which the lower branch includes a delay unit 480 and a complex multiplier 490. Both branches lead to complex multiplier 470. Complex multiplier 470 multiplies the input sample with the output from delay unit 480. The output of delay unit 480 is thus a delayed version, generally by one sample period, of the complex conjugate of the input. The complex conjugate operation is carried out at complex conjugate calculation unit 490.

The output of multiplier 470 is separated into its constituent real and imaginary components by means of a real and complex component separator unit 420. The real output is provided to the upper output and the imaginary output is provided to the lower output. The real output is connected to the + input of adder 440. The imaginary output is connected directly to accumulator 444.

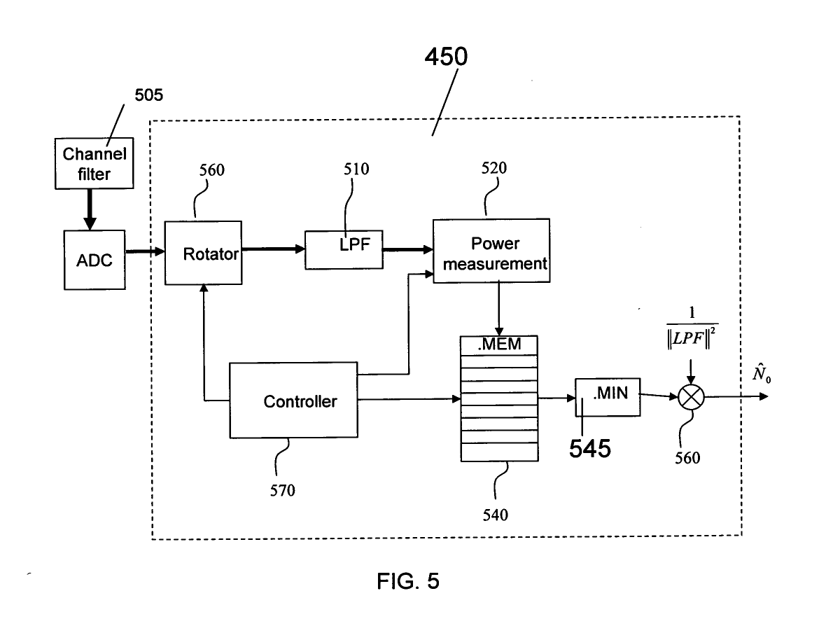

A bias estimator 470 is connected between a power estimator 450 and the − input of adder 440. The output of bias estimator unit 430 is subtracted from the real output of 420 by adder 440, and the result is a real value. In order to perform correct bias estimation, bias estimator unit 430 uses an estimation of the noise power density that is provided by power estimator unit 450. The power estimation unit is discussed in greater detail with respect to FIG. 5 below. The signal composed of the real value at the output of 440 and the imaginary value at the lower output of 420 thus contains unbiased information on the frequency offset of the filtered input signal. This information is averaged by accumulator 444 and extracted by phase extractor unit 460, which outputs the phase of the signal presented at its input, by using a look-up table, for example. The frequency estimation circuit 400 may then be used in a feedforward or feedback manner as desired to carry out the compensation, in the same way as traditional frequency compensation systems, see FIGS. 1-3 above. Thus compensation is now carried out on an unbiased signal.

The basic functions of the receiver, including automatic gain control (AGC), timing recovery, matched filtering/equalization and phase estimation and compensation, now become feasible since a signal is available in which offset compensation was carried out without bias.

FIG. 5 shows a possible implementation of the noise power estimator 450 in circuit 400, in accordance with the embodiment of FIG. 4. The received signal is filtered by filter 505 and then sampled at ADC 507. The sampled signal then enters rotator 560 which shifts the frequency. From the rotator the signal with shifted frequency passes to a narrow band low pass filter or LPF 510 and from there to power measurement unit 520, which measures the power output of the filter. As the frequency is shifted by rotator 560, the power output of the narrow band filter varies. A memory register 540 receives the output of the power measurement unit and a minimum register 545 takes a minimum value from the memory register. A controller 570 sends control signals to the rotator, the power measurement unit and the memory register. The output of the minimum register is fed to multiplier 560 where it is multiplied by the reciprocal of the square of the modulus of low pass filter 510 coefficients to produce a normalized final output \hat{N}₀, as will be explained in greater detail below.

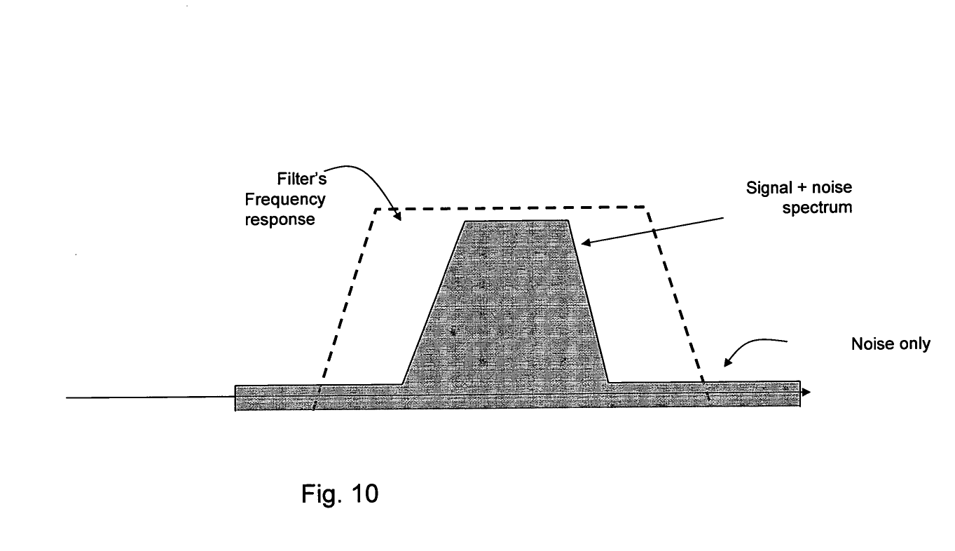

In use, the receiver may be required to accommodate frequency offsets, and thus a 3-dB cutoff frequency may be provided to filter 505 as this would usually be greater than the highest frequency of the desired signal (see FIG. 10 below for clarification). At passband, the frequency response of the filter 505 is relatively flat. It is appreciated by those with ordinary skill in the art, that the noise power spectral density is also flat in that region. Hence, according to one version of the present embodiment, one can filter the received signal with a very narrow lowpass filter 510, and at the time shift the signal in the frequency domain, using rotator 560. The output power of filter 510 is computed in unit 520 and recorded in memory device 540. The frequency shift may then be adjusted to another frequency and a new power may be computed and recorded. The frequency step between one measurement and another should be related to the bandwidth of the lowpass filter; if the 3 dB cutoff frequency of the lowpass filter is w, the frequency step should preferably be less or equal to 2w. Clearly, lower step size means better noise power estimation, but requires more hardware and time. Such a mechanism allows the received signal to be scanned, and an average power spectrum estimation may be produced. The frequency range of the sweep may be limited to the passband region of the filter. Controller 570 may control the sweep process.

After completing a scan of the entire relevant spectrum, a series of power values are stored in memory register 540. The minimal power value is selected by minimum register 545 and is assumed to be the one corresponding to the noise only component (see FIG. 10 discussed below). Assuming that the minimum power is obtained from a noise-only component, the minimal measured power at the filter's output (P) is related to the one-sided power spectral density of the noise and the lowpass filter's impulse response by

$$P = {N}_{0} {\sum }_{i = 1}^{{N}_{g}} {\vert {g}_{i} \vert}^{2}$$

where {gᵢ}ᵢ₌₁ⁿ^{_{g}} are the lowpass filter's coefficients and N_{g} is the size of the lowpass filter. For the sake of brevity, we use the abbreviation

$${‖ LPF ‖}^{2} = {\sum }_{i = 1}^{{N}_{g}} {\vert {g}_{i} \vert}^{2}$$

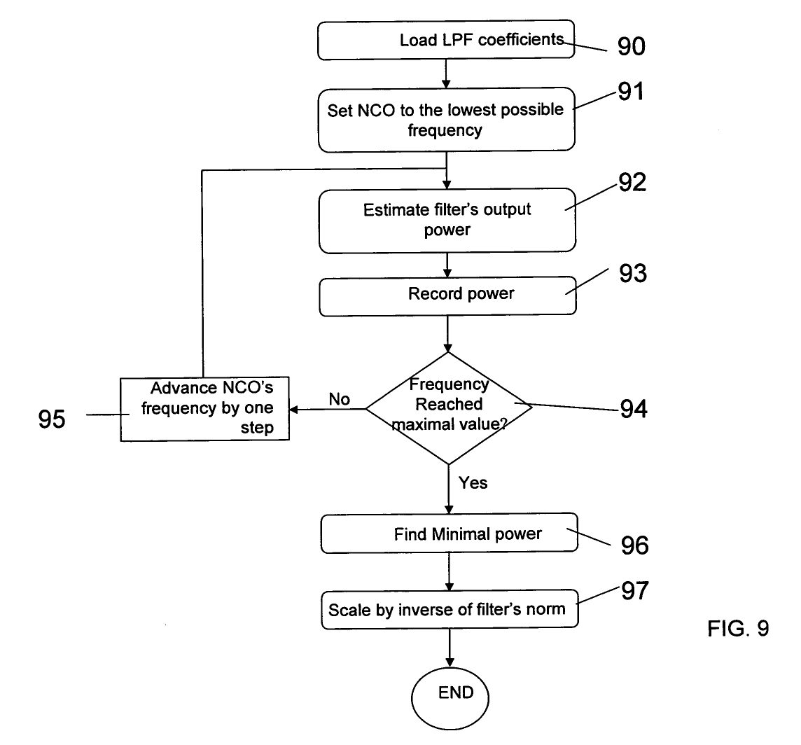

to denote the norm lowpass filter 510. Hence, to obtain an estimation of the one-sided power spectral density of the Gaussian noise, multiplier 550 normalizes the power measurement by the inverse or reciprocal of the norm of filter 510. In order to further clarify the above method, FIG. 9, discussed in greater detail below, contains a flow chart which illustrates the present procedure.

Returning to circuit 400, we elaborate on the functioning of bias-estimation unit 430. As discussed in the background section, the correlation of the noise is directly related to the deterministic autocorrelation function of the filter at the output of the tuner. The bias value b is actually

b=N₀Rₕ(Tₛ)

and it clearly depends on the sampling frequency as well as the filter impulse response. Therefore, unit 430 multiplies the noise spectral density estimation from 450 by the value of Rₕ(Tₛ). The information on Rₕ(Tₛ) may be obtain in several ways. One example is when the channel filter is of a known type (e.g., Chebyshev, Butterworth, etc.). In such a case, which is common in practice, numerical values of the filtered impulse response can be calculated in advance using methods known to anyone who is skilled in the art. The computation of Rₕ(Tₛ) is then straightforward from Eq. (3). Since there is a degree of freedom in the coefficients of the filter with respect to its gain, it is recommended to normalize the filter coefficient such that the sum of the coefficients is 1 (which is appreciated to be equivalent to a DC gain of 1); The gain of the actual channel filter (if it exists) is absorbed into the estimation of N₀.

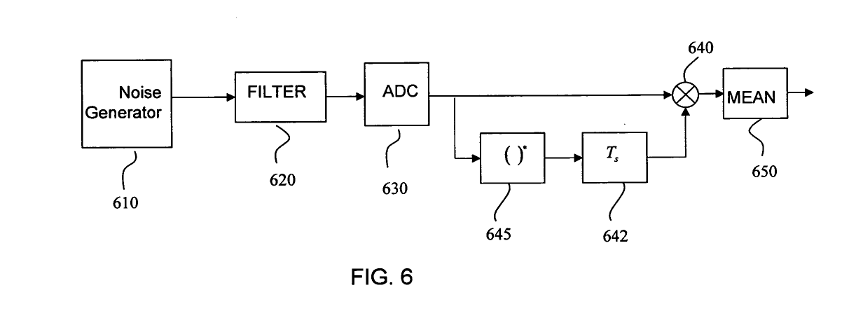

When numerical values of the impulse response are not available, it is suggested according to the present embodiments to use the system in FIG. 6, as a preparatory step, before demodulating the signal. According to one embodiment, also included in the present invention, white noise source 610 produces a controlled Gaussian noise, which is passed through the filter 620, which is the filter used for the received signal. It should be noted that the noise single-sided power spectral density may be normalized to unity, (normalizing circuitry not shown). The output of the filter is sampled by A to D Converter 630, and the resulting samples are fed into a complex multiplier 640, which multiplies every sample with its Tₛ-delayed, conjugated version supplied by the lower branch and via complex conjugate unit 645 and delay unit 642. Averager or mean calculation unit 650 produces at its output the mean value of the signal at its input. That mean value is an estimation of Rₕ(Tₛ).

In order to make the proposed method more flexible, it is possible to compute Rₕ(Tₛ) for a variety of sampling frequencies, and store the results in a memory device (not shown). In such a way it is possible to switch between multiple sampling frequencies as desired, with no need to calculate Rₕ(Tₛ) every time again.

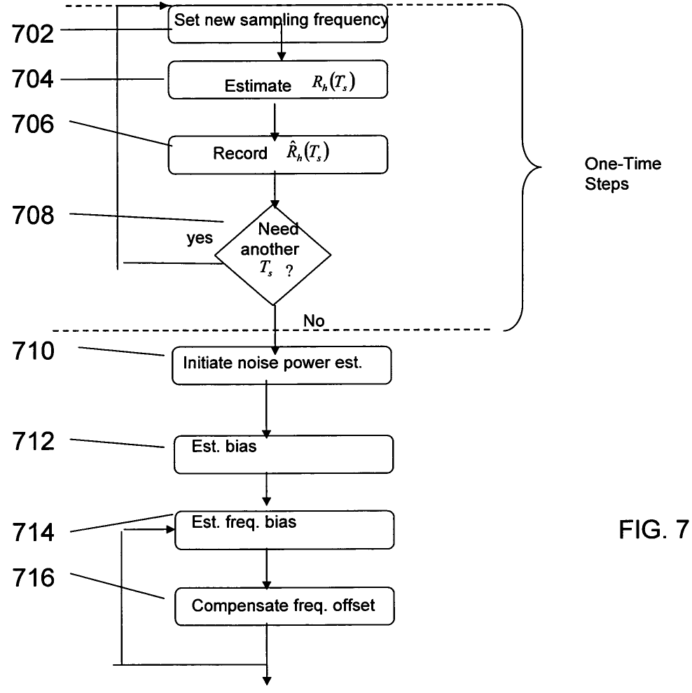

Reference is now made to FIG. 7, which is a simplified flow chart illustrating a method of estimating a carrier frequency according to an embodiment of the present invention. For illustration purposes, the method of estimating the carrier is described below, with reference to FIGS. 1 to 6 discussed above.

In a preparatory stage, that is the part including boxes 702 to 708, the value of Rₕ(Tₛ) is computed for a variety of sampling frequencies. First a sampling frequency is set in block 702, then an estimate is made of Rₕ(Tₛ) in block 704 and then in block 706 the specific value is recorded. In stage 708 a decision is made as to whether to compute for another sampling frequency or not. The computation itself can be done using one of the two methods described above, or any other method. Those values may be stored in a memory device. As explained, for known filters, this stage may be dispensed with since the response can be calculated in advance.

With the estimates stored, an actual sampling frequency is selected and the relevant value of Rₕ(Tₛ) may be read out from storage. At this stage, a noise power estimation sequence may be initiated—block 710, to compute the noise one-sided power spectral density N₀, according to the method illustrated specifically in FIG. 5—block 712. After N₀ is obtained, it is then possible to turn on the frequency estimation process, depicted in FIG. 4—block 714. Finally, to compensate the estimated frequency, a feedforward or a feedback setup may be implemented in block 716.

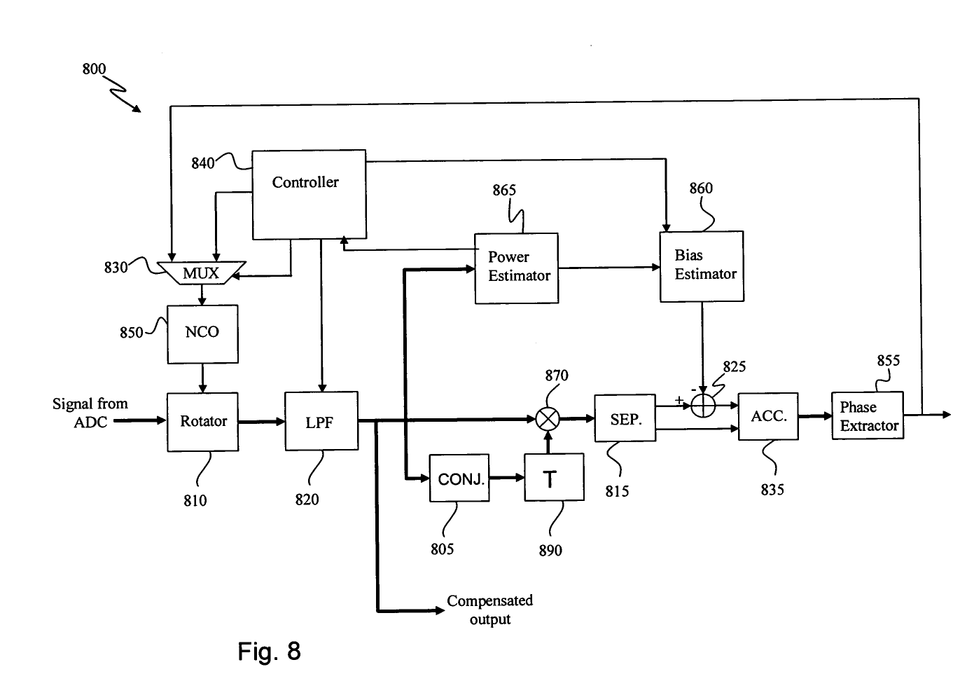

Reference is now made to FIG. 8, which is a simplified block diagram showing a second embodiment of the present invention. As illustrated schematically in FIG. 8, the sampled signal from the A to D Converter, (analogous to 507 in FIG. 5), is shifted in frequency by rotator 810. The output of rotator 810 may pass through an input lowpass filter 820, whose impulse response is known exactly. Thus the dependence on the analog outer filter (analogous to BPF 505 in FIG. 5) is removed, and there is no need to perform the complex autocorrelation function estimation as per the previous embodiment. According to the present embodiment, the analog outer filter may have a cutoff frequency larger than the cutoff frequency of internal digital low-pass filter 820. To save hardware resources, filter 820 and filter 510 in the power estimation unit 500, may share the same hardware, using techniques known to those with ordinary skill in the art.

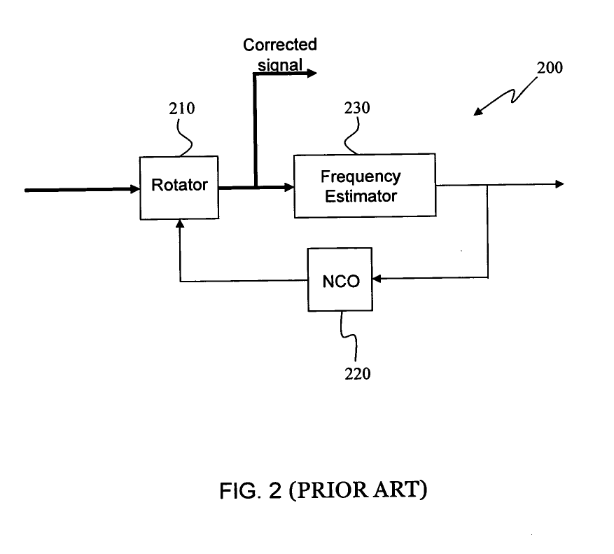

In the present embodiment, it is also possible to use a single rotator 810 to do the tasks of both rotator 210 in FIG. 2 and rotator 560 in FIG. 5, in a sequential manner, according to the method described in FIG. 7. At the start, a control unit 840 loads filter 820 with coefficients which produce narrow lowpass filtering. During the power spectrum estimation sequence, controller 840 changes the frequency of numerically controlled oscillator NCO 850 according to the power estimation method described with respect to FIG. 5. Power estimator 865 computes the power of the signal at the output of LPF 820. When power spectrum estimation has been completed, controller 840 calculates the one-sided noise power density, and sends the result to bias estimator unit 860. After the noise power estimation sequence is complete, the controller loads filter 820 with appropriate coefficients such that the input signal is filtered properly. By ‘properly’ is meant that the new cutoff frequency is such that as much as possible of the noise and adjacent channels is removed, yet without distorting the desired signal. Additionally, the controller computes Rₕ(Tₛ) from the impulse response the filter 820 with its newly loaded coefficients. Computation uses known methods, and the result is passed to bias estimator 860. At this stage, bias estimator 860 is ready to produce a valid estimation of the estimator bias which is the multiplication of the N₀ estimation and Rₕ(Tₛ). A complex multiplier 870 multiplies the input sample with the output from delay unit 890. The output of delay unit 890 is a delayed version of the complex conjugate of the input. The complex conjugate operation is done at complex conjugate calculation unit 805. The output of multiplier 870 is complex and is separated into its constituent real and imaginary components by means of a separator unit 815. The output of bias estimator unit 860 is subtracted from the real output of 805 at adder 825. The signal composed of the real value at the output of 825 and the imaginary value at the lower output of 805 now contains unbiased information on the frequency offset. This unbiased information is averaged by accumulator 835 and extracted by phase extractor 855. Phase extractor 855 outputs the phase of the signal appearing at its input, by using a look-up table, for example. The output of phase extractor 855 is fed to and drives NCO 850, which in turn controls the phase of rotator 810. As mentioned above, the controller 840 controls the NCO 850 during the power estimation stage but during this later phase of frequency bias estimation the loop from the phase extractor is in control. Switchover between controller and loop control is carried out by multiplexer 830, which is itself controlled by controller 840. The output of the low pass filter LPF during loop control is a compensated output.

The procedure of estimating the residual frequency offset and compensating therefor is repeated over and over again during a transmission.

Reference is now made to FIG. 9, which is a simplified flow chart illustrating the use of the apparatus of FIG. 2 for obtaining the noise power spectral density, in accordance with an embodiment of the present invention. In stage 90, coefficients are loaded into the low pass filter 510. A numerically controlled oscillator is set to the lowest frequency of a frequency sweep 91. The filter's output power is estimated 92. The estimated power is recorded 93. If the maximum frequency has not yet been reached then decision box 94 replies no and box 95 is reached in which the next frequency up is selected and a new filter power output is estimated.

Once the sweep is completed then box 96 is entered and the frequency with the minimal power is selected. Finally in box 97 the output is scaled by the inverse of the filter's norm for the current filter coefficients, and the result is used as the noise power spectral density.

Reference is now made to FIG. 10 which is a graph illustrating the filter, signal and noise spectra. The filter spectrum, assuming that the channel filter is bandpass, is shown by hatched line 100. The combined signal plus noise spectrum is shown by shaded region 102. It is clear that the part of the channel filter spectrum with the lowest power is a good guess at a noise only region.

Although a few embodiments of the present general inventive concept have been shown and described, it will be appreciated by those skilled in the art that changes may be made in these embodiments without departing from the principles and spirit of the general inventive concept. One example of such a modification is the frequency estimator called the “D-spaced estimator”. In that estimator a complex multiplier multiplies the input sample by a D sample-periods delayed version of its conjugate. This scheme is appreciated to have a lower estimation error variance. The D-spaced estimator suffers from a bias, which is proportional to Rₕ(DTₛ) rather than to Rₕ(Tₛ). The present embodiments can be used to compensate this bias as described above, with the only difference being that of computing Rₕ(DTₛ) rather than Rₕ(Tₛ).

It is expected that during the life of a patent maturing from this application many relevant receiver and bias estimation systems will be developed and the scope of the terms used herein are intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

We claim:

1. A digital receiver apparatus for providing frequency offset compensation in the presence of filtered noise, comprising:
a tuner having an analog channel filter and a sampler, the analog channel filter for excluding unwanted channels and noise, the tuner providing a filtered sampled output with non-white noise, the non-white noise giving rise to a frequency bias within said output;
a bias estimator associated with the sampled output of the channel filter, configured for estimating said frequency bias due to the non-white noise; and
an offset compensation mechanism, connected to said bias estimator, configured to use said bias estimate to provide compensation therefor, thereby to provide a bias compensated signal, therefrom to carry out frequency offset compensation.

2. Apparatus according to claim 1, wherein said bias estimator is configured to calculate said bias from a function of the impulse response of the channel filter and the deterministic autocorrelation function of said channel filter impulse response.

3. Apparatus according to claim 2, wherein said bias estimator is configured such that the calculation of said impulse response is obtained from a power spectral density of said filtered noise.

4. Apparatus according to claim 3, wherein said bias estimator is configured to feed said power spectral density to be subtracted from a real part of a first complex signal to form a subtracted real part, said first complex signal being a multiplication of the sampled signal with a delayed complex conjugate of itself, the subtracted real part together with an imaginary part of said first complex signal, thereby comprising unbiased information on the frequency offset of the filtered input signal.

5. Apparatus according to claim 4, wherein said bias estimator is connected downstream of a power estimator, and said power estimator is configured to obtain said noise power spectral density by carrying out a sweep of frequencies to determine a minimal power frequency at which power is minimum, said minimal power frequency being taken as a frequency at which said non-white noise is dominant, said power spectral density being extracted from said minimal power frequency, as said noise power spectral density.

6. The apparatus of claim 2, further comprising an autocorrelation function estimator to estimate the autocorrelation function of said channel filter, the autocorrelation function estimator comprising:
a white Gaussian noise generator for passing white Gaussian noise through the channel filter;
an analog-to-digital converter ADC to convert the channel filter's output to digital form; and
a multiplier for multiplying the output of the channel filter with a delayed complex conjugate of itself, the mean thereof providing the autocorrelation function of the input digital signal.

7. The apparatus according to claim 5, wherein the power estimator comprises:
a frequency shifter, configured to shift the spectrum of the input signal, such that intended frequency content is placed around zero frequency;
a digital low-pass filter located downstream of said frequency shifter to filter high frequency content from the shifted signal;
a power estimator located downstream of the low-pass filter to obtain an estimate of the power of the filtered signal;
a controller to control the frequency shifter to carry out said sweep of the frequencies of the signal, such as to allow said estimate to be obtained for each frequency; and
a memory device to record respective power estimations of the different frequency regions of the signal, such that said minimum power frequency is determinable.

8. The apparatus according to claim 7, comprising:
a second frequency shifter to shift a digital signal received from a tuner to a desired frequency;
a first digital low pass filter initially configured with filter coefficients to enable power spectrum estimation;
and a numerically-controlled oscillator (NCO) controllable by an offset compensated phase extracted and fed back from said offset estimator after said power spectral density estimation to provide a signal to said first low pass filter, said lowpass filter being configurable with further coefficients, thereby to allow said low pass filter to provide a compensated output.

9. Apparatus according to claim 8 wherein said first lowpass filter and a lowpass filter of the power estimation unit comprise configurations of the same hardware.

10. A method of compensating for bias due to sampled filtered noise of a channel filter, thereby to allow for unbiased compensation of a frequency offset, the method comprising:
estimating autocorrelation functions for the impulse response of the channel filter over a range of frequencies;
selecting one of said frequencies for use;
estimating a noise spectral density of said sampled filtered noise at said selected frequency;
reading the autocorrelation function corresponding to the selected frequency;
estimating the frequency bias as a function of the noise spectral density and the autocorrelation function for the selected frequency; and
using the bias estimate to compensate for the bias, thereby to form an unbiased signal for frequency offset compensation.

11. Method according to claim 10, wherein said estimating the noise spectral density comprises:
sweeping a plurality of frequencies to obtain a minimal power frequency; and
obtaining the power spectral density of said minimal power frequency.

12. Method according to claim 10, wherein said estimating the autocorrelation functions comprises multiplying the received signal by a delayed complex conjugate of itself to produce a first complex signal having a real part and a complex part.

13. Method according to claim 10, wherein said estimating the frequency bias comprises subtracting the noise spectral density from the real part to form a subtracted real part, a signal comprising unbiased information of said frequency offset thereby being set up in a second complex signal formed from said complex part and said subtracted real part.
